(19) United States
(12) Patent Application Publication
(10) Pub. No.: US 2015/0176926 A1
(43) Pub. Date: Jun. 25, 2015

(54) HEAT EXCHANGER AND MANUFACTURING METHOD THEREOF

(71) Applicant: KABUSHIKI KAISHA TOSHIBA, Minato-ku (JP)

(72) Inventors: Satoru ASAI, Chigasaki (JP); Hiroyuki TAKEBAYASHI, Yokohama (JP); Yoshihiro FUJITA, Kawasaki (JP)

(73) Assignee: KABUSHIKI KAISHA TOSHIBA, Minato-ku (JP)

(21) Appl. No.: 14/642,820

(22) Filed: Mar. 10, 2015

Related U.S. Application Data
(63) Continuation of application No. PCT/JP2014/000895, filed on Feb. 21, 2014.

(30) Foreign Application Priority Data
Feb. 25, 2013 (JP) 2013-034980

(51) Int. Cl. F28F 9/26; B23P 15/26

(52) U.S. Cl. CPC F28F 9/26; B23P 15/26

(57) ABSTRACT

A heat exchanger of an embodiment includes: a first and a second base metal, at least one of the base metal being made of stainless steel; and a joining part joining the first and second metals, including 92 mass % or more of Ni, and formed by MIG welding.

### CROSS-REFERENCE TO RELATED APPLICATIONS

This application is a continuation of prior International Application No. PCT/JP2014/000895 filed on Feb. 21, 2014 which is based upon and claims the benefit of priority from Japanese Patent Application No. 2013-034980 filed on Feb. 25, 2013; the entire contents of all of which are incorporated herein by reference.

### FIELD

Embodiment described herein relate generally to a heat exchanger and a manufacturing method thereof.

### BACKGROUND

In heat exchangers, stainless steel is often used as their structural material because they require heat resistance, pressure resistance, and corrosion resistance, and metal containing copper or aluminum having a high thermal conductivity is often used as their heat transfer material. These various kinds of metals (base metals) are metallurgically joined (welded) by a common material and a different material.

Considering heat transfer, a joining part preferably has a high thermal conductivity. For this purpose, it can be thought to weld the base metals by using a welding material containing Cu.

However, when the base metals such as stainless steel are welded by using the welding material containing Cu, a crack sometimes occurs. For example, there have been cases where a crack occurred in stainless steel when the stainless steel and a mild steel fin were welded by copper solder, and cases where a crack occurred in a precision steel pipe when the precision steel pipe was welded by brass solder.

When a base metal is stainless steel and a welding material contains Cu, there is a possibility that a crack occurs in a joining part due to the Cu penetration of grain boundaries in the stainless steel. Further, when a welding material is diluted by a base metal, there is also a possibility that a crack occurs because a mutual solubility limit of Cu and Fe is low and melted Cu (or Fe) precipitates.

A possible way to prevent a crack may be to add a layer of Ni- or Ni-Cu-based material (intermediate layer) to the base metal before the welding. Further, by using MIG (metal inert gas) brazing, it is possible to reduce the dilution of the welding material. However, even the use of these methods involves a possibility that a crack occurs when a stress of the joining part is large.

### BRIEF DESCRIPTION OF THE DRAWINGS

FIG. 1A is a schematic view illustrating an example of a joining structure in a heat exchanger according to one embodiment.

FIG. 1B is a schematic view illustrating an example of the joining structure in the heat exchanger according to the embodiment.

FIG. 2A is a schematic view illustrating an example of a joining structure in the heat exchanger according to the embodiment.

FIG. 2B is a schematic view illustrating an example of the joining structure in the heat exchanger according to the embodiment.

FIG. 3 is a table presenting an example of components of a welding material according to the embodiment.

FIG. 4 is a table presenting thermal conductivities and so on of welding materials in a comparative manner.

FIG. 5 is a graph presenting a relation between a welding current and a melting amount.

FIG. 6 is a table presenting welding results in an example.

FIG. 7 is a photograph presenting a crack occurring in a comparative example due to the Cu penetration of grain boundaries.

FIG. 8 is a table presenting a relation between a film thickness of Ni plating and the penetration of grain boundaries in a comparative example.

FIG. 9 is a table presenting a relation between the Cu content and the penetration of the grain boundaries in the comparative example.

### DETAILED DESCRIPTION

A heat exchanger of an embodiment includes: a first and a second base metal at least one of which is made of stainless steel; and a joining part joining the first and second base metals, containing 92 mass % or more of Ni, and formed by MIG welding.

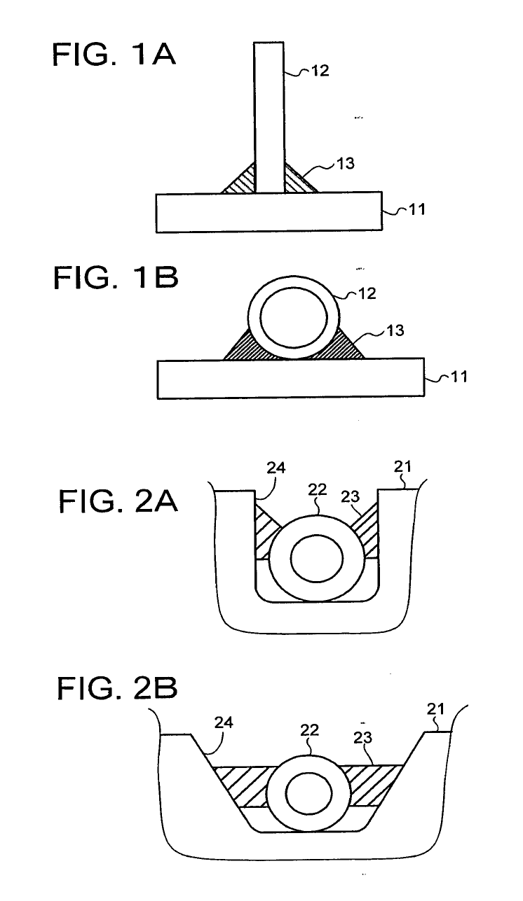

FIG. 1A and FIG. 1B are schematic views illustrating examples of a joining structure in a heat exchanger according to an embodiment. These joining structures each include a base metal 11, a base metal 12, and a joining part 13.

The base metal 11 and the base metal 12 are each a plate member (member in a flat plate shape), or a pipe member (member in a pipe shape). Examples of the combination of the base metal 11 and the base metal 12 are plate member-plate member, plate member-pipe member, and pipe member-pipe member. For example, in FIG. 1A, the base metal 11 and the base metal 12 are two plate members combined in a T-shape (plate member-plate member). In FIG. 1B, the base metal 11 and the base metal 12 are the combination of a plate member and a pipe member (plate member-pipe member).

The plate member is, for example, a structural material of the heat exchanger and is made of, for example, stainless steel in consideration of strength and so on. The pipe member is, for example, a cooling pipe of the heat exchanger, and is made of, for example, copper or an alloy having copper as a main component in consideration of thermal conductivity.

Here, at least one of the base metal 11 and the base metal 12 is made of stainless steel (more concretely, austenitic stainless steel represented by SUS304, 304L, 316, and 316L). Stainless steel has a possibility to crack at the time of welding, and by combining it with a later-described welding material, the reduction of the crack at the time of the welding and so on are enabled.

In the heat exchanger, the base metal 11 and the base metal 12 each sometimes form, for example, a member for heat transfer such as a pipe having a cooling medium flow therein, or a cooling fin. In this case, a small-thickness (thin) material is used for one or both of the base metal 11 and the base metal 12. As will be described later, in this case, welding with a low heat input is desired. Note that the thin thickness refers to a thickness equal to 3 mm or less.

The joining part 13 joins the base metal 11 and the base metal 12, and is one resulting from the solidification of the welding material melted at the time of the welding. As will be described later, the welding material contains 92 mass % or more of Ni.

Here, in the heat exchanger, a deposition area of the joining part 13 (cross sectional area of boundaries between the joining part 13 and the base metals 11, 12) is preferably large in order to improve cooling efficiency.

As illustrated in FIG. 1A and FIG. 1B, in the joining structure of the heat exchanger, a fillet joint (fillet weld) where the joining part 13 has a substantially triangular cross section is often used. In FIG. 1A, the joining part 13 having corners between the plate members combined in the T-shape is disposed. In FIG. 1B, the joining part 13 having corners between the plate member and the pipe member is disposed.

In the fillet welding, at the time of the welding, a tensile stress is likely to concentrate on the corners of the joining part, which is likely to cause the occurrence of a crack.

Another joining structure of the heat exchanger, besides the fillet joint, is a groove joint (groove weld). FIG. 2A and FIG. 2B illustrate examples of the joining structure of the groove joint. This joining structure includes a base metal 21, a base metal 22, and a joining part 23. In a groove 24 of the base metal 21, the base metal 22 is disposed. Further, the joining part 23 joins the base metal 22 and an inner surface of the groove 24. In the groove welding as well, a tensile strength is likely to concentrate on corners of the joining part 23 at the time of the welding, which is likely to cause the occurrence of a crack.

As described above, the welding in the heat exchanger has requirements such as the following (1) to (5), for instance.
(1) A stainless steel material is often used as the base metals 11, 12.
(2) The joining part 13 is likely to suffer a crack due to a stress concentration, as in the fillet welding.
(3) The joining part 13 needs to have a good thermal conductivity in view of heat transfer.
(4) The base metals 11, 12 are often thin in view of heat transfer.
(5) The deposition area of the joining part 13 is preferably large in view of heat transfer.

It is not necessarily easy to satisfy part or all of these requirements at the same time. For example, when the joining part 13 is made of a Cu-based material or a Cu-Ni-based material, the thermal conductivity can be good. However, when the base metals of stainless steel are joined by the fillet welding by using the Cu-based material or the Cu-Ni-based material, there is a high possibility that a crack occurs. For example, Cu in the welding material enters a grain boundary of the stainless steel, which leads to a possibility that a crack due to embrittlement of a liquid metal occurs. Further, when a large amount of the welding material is diluted by the base metals, there is a possibility that a crack occurs because, due to a low mutual solubility limit of Cu and Fe, melted Cu (or Fe) precipitates.

In this embodiment, as the welding material, a metal material not practically containing Cu and containing more than 92 mass % Ni is used. As a result, fillet welding or the like not causing the occurrence of the penetration of the grain boundaries becomes possible.

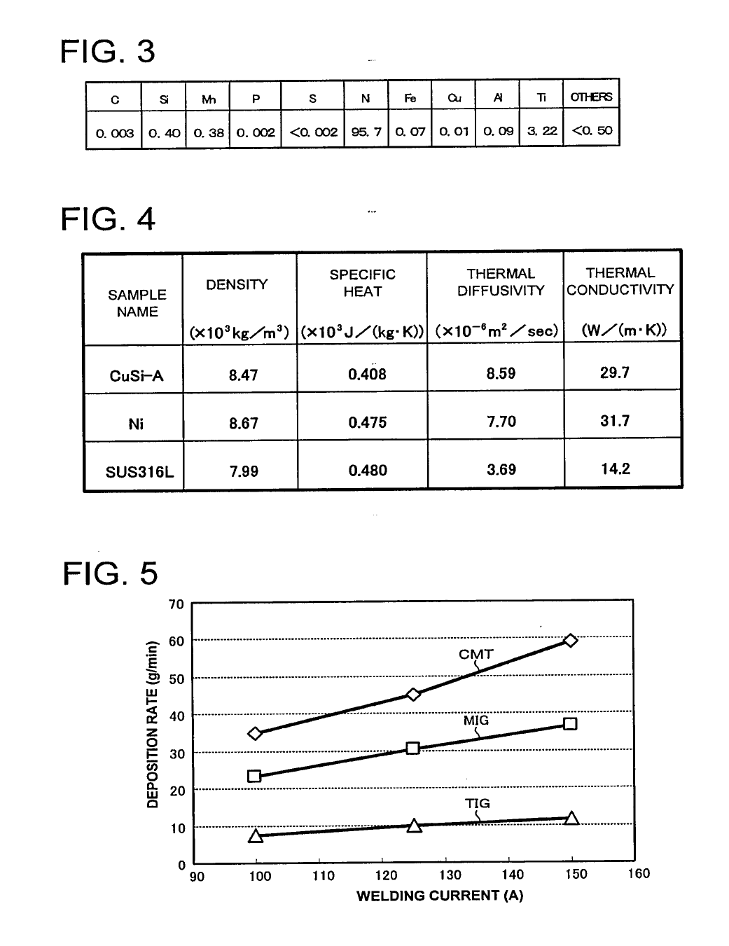

A more preferable welding material is one containing 92 mass % or more of Ni, 1.5 mass % or less of Al, and 3.5 mass % or less of Ti, with C, Si, Mn, P, S, Fe, and Cu each being 1 mass % or less. FIG. 3 presents an example of components of the welding material (unit: mass %). This welding material contains about 95 mass % or more of Ni, 0.1 mass % or less of Al, 3.5 mass % or less of Ti, 0.1 mass % or less of Fe, and 0.5 mass % or less of Si and Mn, with C, P, S, and Cu each being 0.02 mass % or less.

Any of these welding materials does not practically contain Cu, and therefore a crack due to the Cu penetration of the grain boundaries does not occur even when the base metals are stainless steel. Further, any of these welding materials does not practically contain Cu, and therefore, a crack ascribable to the solubility limit does not occur, either, even when a large amount thereof is diluted by the base metals.

The welding material whose Ni content ratio is 92 mass % or more has a 29.7 W/m·K or more of thermal conductivity, and has a thermal conductivity equivalent to or more than that of a Cu-based material. In order to increase cooling efficiency of the heat exchanger, the joining part 13 preferably has a 30 W/m-K or more of thermal conductivity.

As is seen in a comparison table of thermal conductivities in FIG. 4, a thermal conductivity (31.7 W/m·K) of Ni is higher than a thermal conductivity (14.2 W/m·K) of stainless steel (here SUS316L) forming the base metals 11, 12, and is comparable to a thermal conductivity (29.7 W/m·K) of a CuSi-based welding material which is ordinary as a welding material. That is, the joining part 13 has a thermal conductivity equivalent to or higher than that of the base metals 11, 12.

As a welding method, MIG (Metal Inert Gas) welding with a low heat input is usable. The MIG welding is a welding method using only inert gas as shielding gas. That is, the welding is performed in a state where the base metals and the welding material are isolated from the atmosphere by the inert gas.

Generally, TIG (Tungsten Inert Gas) welding is often used as welding of thin materials. However, when the thin materials are TIG-welded so that a deposition area becomes large, the thin materials are liable to deform. Specifically, as is seen in FIG. 5, in the TIG welding, a melting amount of a wire per pass is small as compared with MIG welding or CMT welding (kind of the MIG welding). This necessitates multi-pass welding and increases the total amount of the heat input, which may deform the thin materials.

The low heat input means that a heat input amount is 10 kJ/cm or less (for example, 2 to 10 kJ/cm) per bead. At this time, a deposition rate is preferably 30 g/min or more (for example, 30 to 60 g/min). High-speed welding is enabled with a low heat input, so that the joining part 13 with a large deposition area can be formed for the thin base metals 11, 12.

As the low heat input MIG welding, the CMT (Cold Metal Transfer) welding is usable. In the CMT welding method, a welding wire is repeatedly drawn out and drawn back. As a result, a short-circuit current is kept low, enabling the low heat input welding. Specifically, when the welding wire is drawn out toward the base metal and the welding wire comes into contact with the base metal (that is, when a short circuit is detected), the welding wire is drawn back, so that the cutting of droplets is promoted. Automatically repeating the drawing out and the drawing back keeps the short-circuit low, enabling the low heat input welding.

As is seen in FIG. 5, in the CMT welding, a melting amount of the wire per pass is large and an amount of the heat input is small. That is, even when the base metals 11, 12 are thin, the CMT welding method causes no bum-through and causes only a little deformation. Further, using the CMT welding method reduces the number of passes, making it possible to shorten the execution time.

Here, as the shielding gas, gas containing 50 volume % or more of He, with the balance being Ar and inevitable impurities (for example, mixed gas of 75 volume % He and 25 volume % Ar), is used. With shielding gas of pure Ar, arc generated at a tip of the welding wire does not stabilize, and a bead comes to have a meandering shape relative to a welding direction Further, the bead comes to have a projecting shape due to poor wettability, which is likely to cause the occurrence of a crack in an end portion of the bead due to a stress concentration. Using the shielding gas in which 50% or more of He is mixed stabilizes the arc to enable an increase of wettability of the bead. As a result, the shape of the end portion of the bead becomes smooth, which reduces the stress concentration to less unlikely cause the occurrence of a crack. As a result, it is possible to easily increase the deposition area of the joining part 13 and also improve heat exchange efficiency.

### EXAMPLE

An example will be described. In this example, a structure of stainless steel and a pipe of stainless steel are joined by fillet welding.

As a welding material, a material with the composition presented in FIG. 3 was used. Since the welding material does not practically contain Cu, it is possible to weld the stainless steels without causing the occurrence of a crack.

As previously described, this welding material has a thermal conductivity equivalent to or higher than that of the base metals, and comparable to that of a CuSi-based welding material.

### Welding Conditions

Welding conditions of the base metals are as follows.
welding power source: CMT welding power source (manufactured by Fronius)
test material (base metal 11): SUS316L (34 mm sheet thickness)
test material (base material 12); SUS316L (nominal diameter of the pipe 6A, Sch40)
wire feed speed: 8 m/min
wire diameter: 01.0 mm
welding speed: 22 cm/min
shielding gas: 25% Ar+75% He

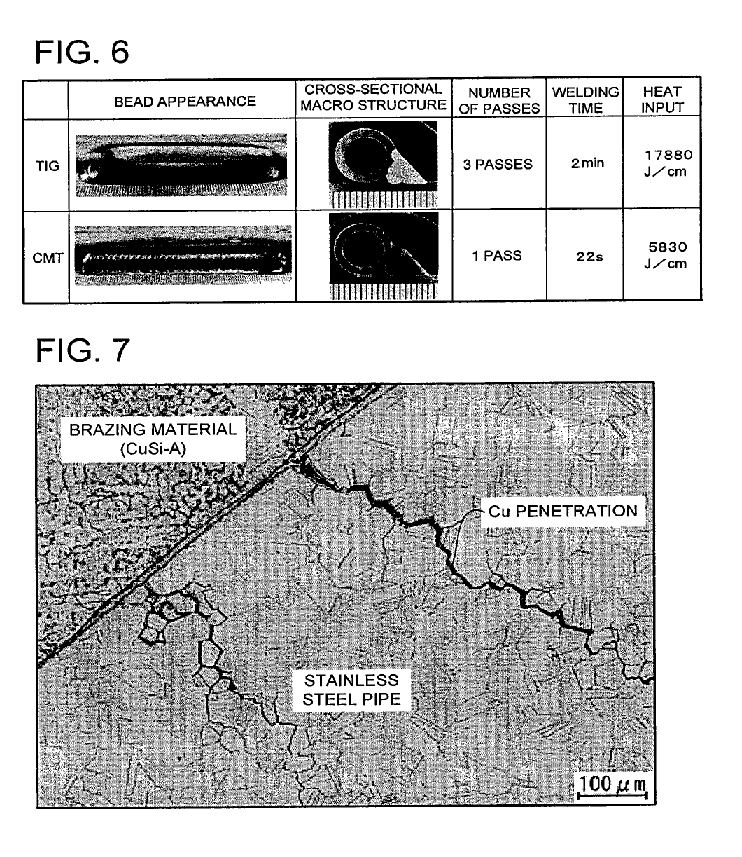

Results of tests where TIG welding and CMT welding were conducted by using this welding material are given in FIG. 6. In the test results, arc stability, bead appearance, and cross-sectional macro structure (presence/absence of a crack ascribable to the penetration of the grain boundaries) were evaluated.

As is seen in FIG. 6, the results of the CMT welding were good. It is seen that, in the CMT welding, since the bead appearance was stable, the arc stability was good. Further, from the observation result of the cross-sectional macro structure, it was confirmed that there was no burn-through and no crack in the pipe. In the TIG welding, though a crack does not occur, the bead appearance is not stable and an amount of heat input is large. Further, as compared with the CMT welding, the TIG welding requires a larger number of passes and a longer work time. It is understood from these results that the CMT welding is superior to the TIG welding both in the welding results and workability, for the welding of base metals, especially for the welding of thin base metals.

### Comparative Example

As previously described, when a base metal is stainless steel and a welding material contains Cu, Cu is likely to enter a grain boundary of the base metal. As a result, the embrittlement of the grain boundary is caused, and a tensile stress works on a joining part to cause a crack. FIG. 7 presents a photograph of a typical state of the crack.

A possible way to prevent a crack may be to add a layer (intermediate layer) of a Ni- or Ni-Cu-based material to the base metal before welding to prevent a crack due to the penetration of the grain boundaries.

However, in a joint having a large stress such as a fillet weld and a groove weld, it is difficult to reduce a crack ascribable to the Cu penetration of the grain boundaries.

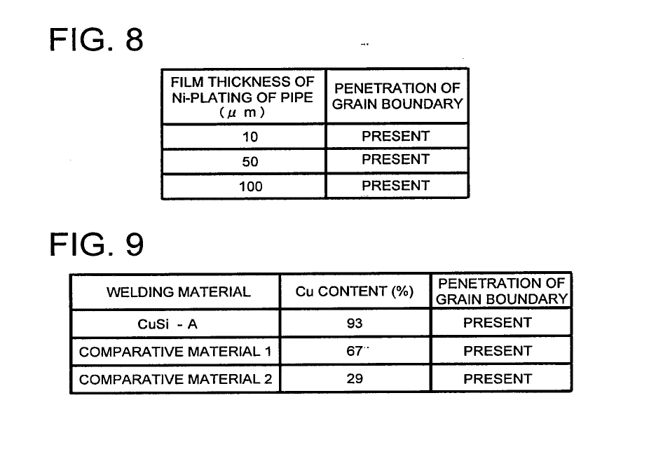

FIG. 8 presents test results when a pipe (base metal) of stainless steel to which an intermediate layer of Ni (Ni plating) was added was welded by using a welding material CuSi-A. Though a film thickness of the Ni plating was varied from 10 to 100 μm, there occurred a crack due to the Cu penetration of grain boundaries of the stainless steel.

FIG. 9 presents test results when the pipe (base metal) of stainless steel was welded, with a Cu content of the welding material being varied from 93 to 29 mass %. In all the cases, a crack ascribable to the Cu penetration of the grain boundaries of the stainless steel occurred.

On the other hand, it is possible to weld the base metal of the stainless steel without any crack by the low heat input MIG welding using the welding material containing Ni whose amount is over 92 mass % as is illustrated in the example. In this case, an intermediate layer of a Ni- and Ni-Cu-based material is not necessary.

According to the embodiment described above, it is possible to prevent a crack in the joining part.

While certain embodiments have been described, these embodiments have been presented by way of example only, and are not intended to limit the scope of the inventions. These novel embodiments may be embodied in a variety of other forms, and various omissions, substitutions and changes may be made without departing from the spirit of the inventions. Such embodiments or modifications are included in the scope and spirit of the inventions and included in the inventions described in the claims and their equivalents.

What is claimed is:

1. A heat exchanger comprising:
a first and a second base metal, at least one of the base metals being made of stainless steel; and
a joining part joining the first and second base metals, the joining part including 92 mass % or more of Ni, and formed by MIG welding.

2. The heat exchanger according to claim 1,
wherein the joining part includes 92 mass % or more of Ni, 1.5 mass % or less of Al, and 3.5 mass % or less of Ti, with C, Si, Mn, P, S, Fe, and Cu each being 1 mass % or less.

3. The heat exchanger according to claim 1,
wherein the joining part has a thermal conductivity of 30 W/m·K or more.

4. The heat exchanger according to claim 1,
wherein the joining part has a fillet shape or a groove joint shape.

5. The heat exchanger according to claim 4,
wherein the first and second base metals have a flat plate shape or a pipe shape.

6. The heat exchanger according to claim 1,
wherein the first and second base metals do not have an intermediate layer of a Ni- or Ni-Cu-based material.

7. The heat exchanger according to claim 1,
wherein the MIG welding is CMT welding.

8. The heat exchanger according to claim 7,
wherein the CMT welding is executed with a 2 to 10 kJ/cm heat input and a 30 to 60 g/min deposition rate.

9. The heat exchanger according to claim 1,
wherein the MIG welding is performed by using shielding gas including 50 volume % or more of He and the balance being Ar and inevitable impurities.

10. A manufacturing method of a heat exchanger comprising:
disposing a first and a second base metal at least one of which is made of stainless steel; and
MIG-welding the first and second base metals by using a welding material including 92 mass % or more of Ni to form a joining part.

11. The manufacturing method of the heat exchanger according to claim 10,
wherein the joining part formed in the step of welding includes 92 mass % or more of Ni, 1.5 mass % or less of Al, and 3.5 mass % or less of Ti, with C, Si, Mn, P, S, Fe, and Cu each being 1 mass % or less.

12. The manufacturing method of the heat exchanger according to claim 10,
wherein the joining part formed in the step of welding has a thermal conductivity of 30 W/m·K or more.

13. The manufacturing method of the heat exchanger according to claim 10,
wherein the joining part formed in the step of welding has a fillet shape or a groove joint shape.

14. The manufacturing method of the heat exchanger according to claim 13,
wherein the first and second base metals have a flat plate shape or a pipe shape.

15. The manufacturing method of the heat exchanger according to claim 10,
wherein the first and second base metals do not have an intermediate layer of a Ni- or Ni-Cu-based material.

16. The manufacturing method of the heat exchanger according to claim 10,
wherein, in the step of welding, the first and second base metals are CMT-welded.

17. The manufacturing method of the heat exchanger according to claim 16,
wherein, in the step of welding, the CMT welding is executed with a heat input of 2 to 10 kJ/cm and a deposition rate of 30 to 60 g/min.

18. The manufacturing method of the heat exchanger according to claim 10,
wherein shielding gas is used in the step of MIG-welding, the shielding gas including 50 volume % or more of He and the balance being Ar and inevitable impurities.
